(19) United States
(12) Patent Application Publication
(10) Pub. No.: US 2022/0260314 A1
(43) Pub. Date: Aug. 18, 2022

(54) Rapid Cooling Debinding and Sintering Furnace

(71) Applicants: Daniel Gelbart, Vancouver (CA); Thomas Robert Curran, Vancouver (CA)

(72) Inventors: Daniel Gelbart, Vancouver (CA); Thomas Robert Curran, Vancouver (CA)

(21) Appl. No.: 17/495,720

(22) Filed: Oct. 6, 2021

Related U.S. Application Data
(60) Provisional application No. 63/149,631, filed on Feb. 15, 2021.

(51) Int. Cl. F27B 5/16; B22F 3/10; B22F 3/00

(52) U.S. Cl. CPC F27B 5/16; B22F 3/10; F27B 2005/064; F27B 2005/166; B22F 3/003

(57) ABSTRACT

The invention uses a furnace retort made of silicon carbide to create a sintering furnace having no cold areas during debinding while having low heat losses during sintering. This is achieved by varying the wall thickness of the retort and taking advantage of the large increase in thermal conductivity of silicon carbide at lower temperatures. The special properties of silicon carbide also allow rapid cooling by exposing the outside of the retort directly to a high flow of cooling air.

### FIELD OF THE INVENTION

The invention relates to furnaces used for converting powders of metals and ceramics into fully dense object by a sintering or a densification process.

### BACKGROUND OF THE INVENTION

Several manufacturing methods convert metal and ceramic powders held together by a binder into solid, fully dense, parts by heating them in a special furnace known as a sintering furnace. Examples of such processes are Powder Metallurgy (PM), Metal Injection Molding (MIM) and recently metal 3D printing. Prior to sintering, the remaining binder has to be removed, an operation known as “debinding”. The vacuum-tight chamber in which the parts are placed to be sintered is known as “retort”.

A highly desirable property of a sintering furnace is the ability to cool the furnace quickly at the end of the sintering cycle, in order to increase the furnace utilization.

Another desirable property of sintering furnaces is to be well insulated, in order to minimize the heating power needed to reach and maintain the sintering temperature. Unfortunately, the last two properties contradict each other: a well insulated furnace will cool slowly unless active cooling is used. The simplest active cooling is forcing a high flow of room temperature air around the retort during the cooling stage. In this disclosure the term “active cooling” and “rapid cooling” mean any method used to cool the furnace faster than it would cool simply by turning off the heating power.

Furnaces can be made with the heating elements inside the retort or with heating elements outside the retort. In general, the retort needs to be vacuum tight as the gas composition during sintering has to be tightly controlled. The present invention relates to furnaces having the heaters located outside the retort. It is desirable to allow the outside of the retort to be exposed to air in order to avoid a second vacuum chamber around the outside of the retort. Current sintering furnaces having heaters outside an uninsulated retort can not tolerate an air stream directed at the retort at sintering temperatures.

Prior art, such as US patent application 20210078075A1 discloses a double-chamber construction, with a double insulation (one insulation inside and one outside the retort). This not only increases complexity but also prevents very rapid cooling because of the internal insulation. Another common approach was to use a ceramic retort with external heating that can be exposed to air, but not use rapid cooling. This is disclosed in WIPO patent application WO2020167802A2. It is an object of the invention to create an externally heated vacuum-tight retort where the outside can be exposed to air and can tolerate very rapid cooling by a strong airflow directed at the retort. Since the heaters and insulation are in ambient air, a large amount of insulation can be used outside of the heated area (to save energy) while achieving rapid cooling. Placing insulation inside the retort has two additional disadvantages beyond limiting the cooling rate: the insulation, as in US patent application 20210078075A1, it will get contaminated by the debinding by-products and it will also increase the time to achieve good vacuum, as most insulation materials are porous. Another object of the invention is to achieve a retort with an optimal heat distribution both during debinding and sintering. The ideal heat distribution will keep the cold end of the retort at a temperature that minimizes condensation while prevent large heat losses via the cold end during sintering.

During the debinding step various gasses are created, mostly hydrocarbons, and it is important to prevent any condensation of those gases inside the retort. If such condensation occurs, the condensed liquids will evaporate at the sintering temperature and contaminate the sintered part.

This requires keeping the whole retort, including the door and the exhaust pipe for the gasses, at a temperature above the condensation temperature of the debinding by-products. Traditionally this was done by adding heaters to the part of the retort outside the heated zone. A high thermal conductivity of the retort helps in preventing the formation of cold spots during debinding.

However, high conductivity is undesirable during sintering, as it will cause large heat losses, as the cold end of the retort will pull out large amounts of heat from the hot end. Typical debinding temperatures are 250 to 500 degrees C., while typical sintering temperatures are 1000 to 1400 degrees C. for metals, reaching 2000 degrees C. for some ceramics. The current invention solves all the above problems while simplifying the construction of the furnace.

### SUMMARY OF THE INVENTION

The invention uses a furnace retort made of silicon carbide to create a sintering furnace having no cold areas during debinding while having low heat losses during sintering. This is achieved by varying the wall thickness of the retort and taking advantage of the large increase in thermal conductivity of silicon carbide at lower temperatures. The special properties of silicon carbide also allow rapid cooling by exposing the outside of the retort directly to a high flow of cooling air.

### BRIEF DESCRIPTION OF THE DRAWINGS

FIG. 1 is a cross section of a Prior Art sintering furnace with an externally heated retort.

FIG. 2 is a cross section of a sintering furnace according to the invention.

FIG. 3 is a graph showing the temperatures along the furnace retort during debinding and sintering.

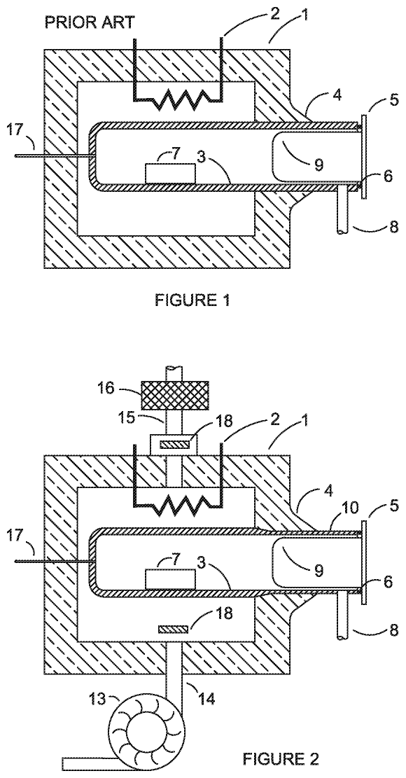

### DESCRIPTION

FIG. 2 show a cross section of sintering furnaces of the externally heated retort type. A retort 3 is externally heated by electrical heater 2 in a well insulated enclosure formed by insulation 1.

Sometimes insulation 1 is shaped with a tapered section 4 to control thermal gradients. The retort 3 is closed by door 5 using a seal 6 to achieve air tightness.

The object to be sintered 7 is placed in retort 3, which is first heated to the debinding temperature and kept at this temperature for a preset time, typically over an hour. The gases produced during debinding are evacuated via pipe 8. Insulated plug 9 protect door 5 and seal 6 from the high temperatures used in sintering. The debinding can be done in vacuum (supplied via pipe 8), in air, or in a process gas atmosphere. Inert or reducing gases can be supplied to the retort by a separate tube 17. In order to cool the furnace rapidly at the end of the sintering cycle, a blower 13 is turned on and cold air flows into the heated space via pipe 14, exiting via pipe 15.

The cold (i.e. room temperature) air is directed at the retort. In this disclosure the phrase “directed at the retort” should be understood as any arrangement causing cold air to flow near the outside of the retort. An air filter 16 can be added to exit pipe 15 to trap dust and cool down the hot air coming out of the furnace. Such a filter should be made of non-flammable materials such as glass fibers. To decrease heat losses radiation shields 18 can be added to prevent radiated heat coming out of the openings used for cooling and limit air convection currents.

Such shields can be fixed or movable. Shields 18 can be moved by the cooling airflow or by an actuator (not shown). Shields 18 are typically made of a refractory material such as porous alumina or zirconia.

Clearly the cooling rate can be increased by many methods, some not requiring a blower.

Creating a large opening in insulation 1 during the cooling phase, allowing room air to come into contact with retort 3 and allowing radiation to escape from retort 3 should be considered active cooling in this disclosure. This opening can be covered up by insulation when rapid cooling is not needed. Bringing a large cold mass into proximity to retort 3 is another form of active cooling.

In the preferred embodiment retort 3 is made of fully dense silicon carbide (SiC), heater 2 is made of a plurality of molybdenum disilicide heaters (known as MoSi heaters), Insulation 1 is made of alumina-silica porous plates, with secondary insulation supplied by an alumina-silica blanket and by microporous insulation board. Door 5 is made of stainless steel, seal 6 is a Viton or silicone rubber O-ring. Insulated plug 9 is made from a large number (10-25) of thin refractory metal discs, typically Molybdenum. Plug 9 can also be a hollow cylinder made of a refractory material, either vented to retort 3 or full of insulating material and sealed. All these materials and construction methods are well known in the art and have multiple suppliers.

Blower 13 is preferably a variable speed blower, such as a 3 phase centrifugal blower controlled by a Variable Frequency Drive (VFD), to achieve a uniform cooling rate or any desired cooling profile. The hot ends of tubes 14 and 15 are made of a refractory material such as alumina or zirconia.

Silicon carbide has been mentioned in prior art as a material to build furnace retorts but not for rapid cooling furnaces where the uninsulated retort is subjected to a stream of cooling air impinging directly on the retort. It was discovered that the unique properties of silicon carbide make it possible to build such a furnace without requiring a double chamber construction as disclosed in US application 20210078075A1. Fully dense silicon carbide has a very low thermal expansion of about 4-5 ppm/degC, very high strength both in compression and tension, good thermal conductivity and no loss of strength at high temperatures. It has the surprising property that it is stronger at 1400 degrees C., a common sintering temperature, than at room temperature.

It was found that this unusual combination of properties allows silicon carbide to tolerate direct rapid cooling by an airstream directed at the hot retort.

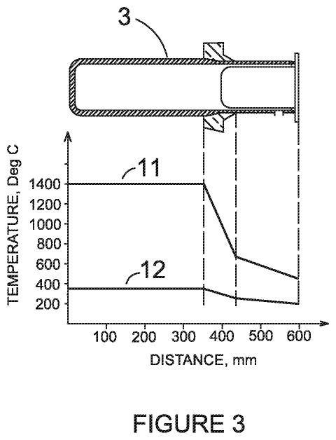

The special properties of silicon carbide also allow a good temperature uniformity along the retort during the debinding stage, while keeping the front of the retort at a fairly low temperature (100 to 250 degrees C.) during the sintering stage. Silicone carbide it is a good thermal conductor at low temperatures and significantly poorer conductor at high temperatures. Fully dense silicon carbide made from small particles has a thermal conductivity of about 100-120 W/m·K at the debinding temperatures (200-400 deg C.), dropping to about 30 W/m·K at common sintering temperatures (1300-1400 deg C.). For some types of silicon carbide low temperature conductivity can be as high as 200 W/m·K, as good as aluminum. This property allows the retort to conduct heat to the plug 9 and pipe 8 during debinding, preventing condensation of the debinding by-products. Once the retort is heated up to the sintering temperature, the retort part going through the insulation 1 stays hot and has a low thermal conductivity, minimizing heat losses. Heat losses are further minimized by varying the wall thickness of the retort. The part inside the insulated cavity is made with a thick wall, typically 6-12 mm thick. This equalizes the temperature along the hot zone of the retort. As the retort passes through the insulation 1, the wall thickness is dropped to 2-4 mm in area 10, minimizing thermal conduction and heat losses. By carefully considering the change in thermal conductivity of silicon carbide with temperature and varying the wall thickness, the temperature profiles shown in FIG. 3 can be achieved.

Referring now to FIG. 3, the graph of the temperature along the retort during debinding 12 and during sintering 11 is shown. During debinding it is desired to prevent large temperature drops towards the front of the retort, to prevent condensation. Sometimes additional heaters are required to heat up the plug 9, door 5 and pipe 8 (see FIG. 2). During sintering it is desired to minimize the heat flow from the hot zone (the sintering area) of retort 3. Because the thinned-out section of the retort passes through the insulation, it stays hot and has a reduced thermal conductivity. Additional cooling of the front part can be supplied by fans.

Because of the ability of silicon carbide to withstand a thermal shock, cold air can be blown into the insulated cavity surrounding the retort to rapidly cool down the retort and the sintered part at the end of the sintering cycle. It was found out that a retort made of fully dense silicon carbide having a diameter of about 250 mm and a length of 650 mm can be cooled down from 1400 degrees C. to 100 degrees C. in as little as 30 minutes without damaging the retort by using a 1 HP centrifugal blower. By comparison, an alumina or zirconia retort of the same size has to be cooled down over 15-20 hours to avoid cracking.

Silicon carbide is a readily available material. Major suppliers are Kyocera (Japan), Kessen (China) and St. Gobain (USA).

1. A sintering furnace comprising of:
a retort made of silicon carbide;
electrical heating elements placed outside the said retort;
thermal insulation surrounding the said heaters and retort, and
a source of cooling air capable of directing cooling air into the space between the thermal insulation and the retort, said cooling air directly touching the retort, to achieve rapid cooling at the end of the sintering.

2. A sintering furnace as in claim 1 wherein the wall thickness of the said retort is changing along the retort, the wall thickness near the colder end of the retort being less than the wall thickness in the hotter areas of the retort.

3. A sintering furnace as in claim 1 wherein the source of cooling air is an electric air blower.

4. A sintering furnace as in claim 1 wherein the source of cooling air is natural convection created by exposing an opening in the said thermal insulation.

5. A sintering furnace as in claim 1 wherein the flow rate of the cooling air is adjustable to control the rate of cooling.

6. A sintering furnace as in claim 1 wherein the cooling air enters and leaves the furnace via holes cut out in the said thermal insulation, the said holes having fixed radiation shields blocking direct thermal radiation from the retort escaping through the said holes.

7. A sintering furnace as in claim 1 wherein the cooling air enters and leaves the furnace via holes cut out in the said thermal insulation, the said holes having movable radiation shields blocking direct thermal radiation from the retort escaping through the said holes.

8. A sintering furnace as in claim 1 wherein the cooling air is passed through an air filter before it leaves the furnace.
